(19) United States
(12) Patent Application Publication
(10) Pub. No.: US 2025/0304742 A1
(43) Pub. Date: Oct. 2, 2025

(54) RAPID-CURING, LOW-TEMPERATURE COMPOSITION FOR THE PRODUCTION OF PRESSURISED TANKS MADE OF A COMPOSITE MATERIAL FOR THE ON-BOARD STORAGE OF HYDROGEN GAS

(71) Applicants: COMMISSARIAT A L'ENERGIE ATOMIQUE ET AUX ENERGIES ALTERNATIVES, Paris (FR); INSTITUT NATIONAL DES SCIENCES APPLIQUÉES DE LYON, Villeurbanne (FR); VITECH COMPOSITES, Sainte-Maure-de-Touraine (FR); CENTRE NATIONAL DE LA RECHERCHE SCIENTIFIQUE, Paris (FR); UNIVERSITE CLAUDE BERNARD – LYON 1, Villeurbanne (FR); UNIVERSITE JEAN MONNET SAINT ETIENNE, Saint-Etienne (FR)

(72) Inventors: Christophe Magnier, Monts (FR); Stéphane Villalonga, Monts (FR); Martin Jegou, Arronville (FR); Sébastien Livi, Villeurbanne (FR); Jean-François Gerard, Bron (FR); Jannick Duchet-Rumeau, Sainte-Euphemie (FR); Frédéric Demaret, Pouzay (FR)

(73) Assignees: COMMISSARIAT A L'ENERGIE ATOMIQUE ET AUX ENERGIES ALTERNATIVES, Paris (FR); INSTITUT NATIONAL DES SCIENCES APPLIQUÉES DE LYON, Villeurbanne (FR); VITECH COMPOSITES, Sainte-Maure-de-Touraine (FR); CENTRE NATIONAL DE LA RECHERCHE SCIENTIFIQUE, Paris (FR); UNIVERSITE CLAUDE BERNARD – LYON1, Villeurbanne (FR); UNIVERSITE JEAN MONNET SAINT ETIENNE, Saint-Etienne (FR)

(21) Appl. No.: 18/864,273

(22) PCT Filed: May 11, 2023
(86) PCT No.: PCT/EP2023/062546

§ 371 Date: Nov. 27, 2024

(30) Foreign Application Priority Data
May 11, 2022 (FR) FR2204456

(51) Int. Cl. C08G 59/40; B29B 11/16; B29K 63/00; B29K 105/06; C08J 5/24; F17C 1/16

(52) U.S. Cl. CPC C08G 59/4071; B29B 11/16; C08J 5/243; F17C 1/16; B29K 2063/00; B29K 2105/06; C08J 2363/02; F17C 2203/0673; F17C 2209/2163; F17C 2221/012

(57) ABSTRACT

Disclosed is a composition comprising 70 to 95 parts by mass of an epoxy resin with a viscosity of less than or equal to 20 Pa·s, for example between 1 and 20, or between 1 and 10, at a temperature of between 20° C. and 25° C., and 5 to 30 parts by mass of a hardener dispersed in the resin, per 100 parts by mass of resin present in the composition, wherein the hardener is an ionic liquid containing a phosphonium cation of formula P(R₁R₂R₃R₄)⁺ wherein R₁, R₂, R₃ and R₄, which may be identical or different, represent a hydrogen atom, an alkyl radical having 1 to 18 carbon atoms, an aryl radical having 6 to 20 carbon atoms, said alkyl and aryl radicals being optionally substituted, and an acetate anion of formula (R₅CO₂)⁻ wherein R₅ represents a hydrogen atom, an alkyl radical having 1 to 18 carbon atoms, an aryl radical having 6 to 20 carbon atoms, said alkyl and aryl radicals being optionally substituted, or a phosphinate anion of formula [[(CH₃)₃CCH₂CH(CH₃)CH₂]₂P(O)O]⁻. Further disclosed is the use of a composition for the manufacture of a hydrogen vessel, in particular a vessel operating under pressure, of types II, III, IV and V, comprising a composite material, for the on-board storage of gaseous hydrogen.

### TECHNICAL FIELD OF THE INVENTION

The present invention relates to the field of manufacturing vessels comprising a composite material, operating under pressure, of types II, III, IV and V, for storing gaseous hydrogen and any other gas of interest under pressure, for applications which are fixed, transportable and mobile, such as, for example, the hydrogen storage infrastructures, the transport of hydrogen for refueling, the hydrogen-powered rail vehicles, the buses, the trucks, the aircrafts, the boats and other hydrogen-powered vehicles, and the hydrogen-powered cars.

### TECHNICAL BACKGROUND

Today, the on-board storage systems for gaseous hydrogen in pressurized vessels for the mobility applications exist, but only a few manufacturers market a few thousand or tens of thousands of approved vessels a year. With the emergence of the market linked to low-carbon mobility and pressure storage, there is no supply chain (transformation of raw materials and components into a finished product that is delivered to the end customer) ready for mass production (millions of units per year) at moderate cost. For example, the compact, reliable, safe and economical storage of gaseous hydrogen at 700 bar is a major challenge for the widespread commercialization of Fuel Cell Electric Vehicles (FCEVs) and other fuel cell applications. While some lightweight FECVs with a range of over 500 km have been appearing since 2015, affordable on-board hydrogen storage is still a major obstacle, and the number of vessels manufactured remains low. Much of the focus of hydrogen storage programmed is on developing cost-effective hydrogen storage technologies with improved energy density (gravimetric capacity of around 6%, i.e. 6% of the mass of the storage system is hydrogen).

The hydrogen vessels for use in cars, buses, trucks, trains, aircrafts and boats are already available, but they do not yet meet all the expectations of manufacturers with a view to the mass production of hydrogen-powered systems. This applies not only to the manufacture of H₂ vessels, but also to the deployment and use of fuel cell mobility means.

Although the cost of manufacturing pressurized vessels of the Type II, III, IV and V comprising a composite material for on-board storage of the gaseous hydrogen represents around 10% to 30% of the cost of the storage system, the mass production capacity is a major challenge for the automotive integrators. The polymerization step (also referred to as curing or baking) of the composite material matrix, which ensures resistance to pressure, is the main step that currently limits the speed of the vessel manufacture. The matrix of the composite material used in pressure vessels is generally an epoxy matrix.

In order to produce several million vehicles a year, the curing time of the matrices of the composite material used for Type II, III, IV and V fuel vessels must be considerably reduced. Today, with epoxy matrices, the duration of the polymerization (or curing) process for a 700 bar pressure vessel is around 12 to 16 hours, which is too long for mass production such as that required for the automotive industry.

The wet filament winding method is generally the most widely used by manufacturers for the manufacture of Type II, III, IV and V pressure vessels.

There is therefore a real need for a new epoxy resin-based composition specific to the wet filament winding method for the manufacture of type II, III, IV and V pressure vessels, comprising a composite material, particularly for the on-board storage of the gaseous hydrogen, which is capable of meeting the constraints of mass production and which is industrially interesting.

In particular, there is a real need for an epoxy resin-based composition as described above which allows the duration of the polymerization step of the matrix of the composite material to be substantially reduced in order to minimize the cycle time for manufacturing a vessel. In some cases, particularly when the vessel is equipped of a polyethylene inner coating or liner, a polymerization at temperatures of 170° C. or less may be required by the manufacturers.

There is therefore a real need for an epoxy resin-based composition such as that described above, which allows manufacturers to easily adapt the temperature of the polymerization step to the nature of the liner when one is present. In this way, the polymerization step may be carried out optimally at any temperature and even at low temperatures, i.e. at maximum temperatures of 170° C. or less, for example at maximum temperatures ranging from 60° C. to 170° C., from 60° C. to 150° C., from 60° C. to 130° C., from 60° C. to 110° C., from 60° C. to 105° C.

The low temperature allows a wider choice of materials to be used for the liner (also referred to as inner coating), and also gives greater latitude for controlling the exothermicity of the cure, particularly when the thickness of the composite material is significant, for example 2 to 5 cm.

To achieve this, the present invention proposes a new epoxy resin-based composition for the composite material that takes account of the technical and regulatory constraints associated with the Type II, III, IV and V composite pressure vessels for on-board hydrogen storage.

### SUMMARY OF THE INVENTION

The present invention relates to a composition (C) characterized in that it comprises
(A) 70 to 95 parts by mass of an epoxy resin with a viscosity of less than or equal to 20 Pa·s, preferably between 1 and 20 Pa·s, more preferably between 1 and 10 Pa·s, at a temperature of between 20° C. and 25° C., and
(B) 5 to 30 parts by mass of a hardener dispersed in the resin,
per 100 parts by mass of resin present in the composition,
and in that the hardener is an ionic liquid containing a phosphonium cation of formula P(R₁R₂R₃R₄)⁺ wherein R₁, R₂, R₃ and R₄, which may be identical or different, represent a hydrogen atom, an alkyl radical having 1 to 18 carbon atoms or an aryl radical having 6 to 20 carbon atoms, said alkyl and aryl radicals being optionally substituted, and
an acetate anion of formula (R₅CO₂)⁻ wherein R₅ represents a hydrogen atom, an alkyl radical having 1 to 18 carbon atoms, an aryl radical having 6 to 20 carbon atoms, said alkyl and aryl radicals being optionally substituted, or
a phosphinate anion of formula (PO₂R₆R₇)⁻ wherein R₆ and R₇, which are identical or different, represent a hydrogen atom, an alkyl radical having 2 to 16 carbon atoms or an aryl radical having 6 to 20 carbon atoms, said alkyl and aryl radicals being optionally substituted.

The vessels comprising a composite material and operating under pressure are classified into the following categories:
the type II vessels, referred to as hooped vessels, are metal vessels reinforced by a circumferential winding of fiber on the cylindrical portion only, generally with carbon or glass (composite reinforcement),
the type III vessels have a metal envelope (also referred to as an inner coating or liner, which acts as a barrier to the gas, and a composite reinforcement over the entire external surface,
the type IV vessels, which differ from the type Ill vessels in that they have a polymer liner, and
the type V vessels, which differ from the type IV in that they do not have a polymer liner.

For example, the type IV pressure vessel, made of composite material, consists of an inner coating made of polymer material, also referred to as liner, most often thermoplastic, with metal connectors, referred to as bosses, at one or both ends. The bosses connect the vessel to the storage system. The liner provides a hydrogen-tight seal. This assembly is covered with a structuring composite material, ensuring structuring under internal pressure, usually comprising a thermosetting matrix, most often an epoxy resin, and a reinforcement most often based on long fibers, for example carbon or glass.

The aim of the present invention is therefore to support the development of on-board compressed gaseous hydrogen storage systems (CGH₂ compressed gaseous hydrogen, CPV Composite Pressure Vessel) in improved pressure vessels, in order to anticipate the future mass deployment of the above-mentioned technologies, in particular by focusing on the composition of the composite material of the vessel, and more specifically on the resin and its polymerization reaction, which has a major impact on production rates over periods of more than 10 hours in general.

The composition of the invention is particularly advantageous because it polymerizes rapidly compared with the epoxy matrix-based compositions used today, thanks in particular to the use of phosphorus ionic liquids as hardeners. The polymerization time of the epoxy matrix in a composition according to the invention is less than 12 hours, less than 10 hours, in particular less than or equal to 8 hours, in particular less than or equal to 6 hours, more particularly less than or equal to 4 hours, and even more particularly less than or equal to 2 hours.

The composition of the invention is also particularly advantageous because the polymerization step may be carried out optimally at any temperature and even at low temperatures, i.e. at maximum temperatures of 170° C. or less, for example at maximum temperatures of from 60° C. to 170° C., from 60° C. to 150° C., from 60° C. to 130° C., from 60° C. to 110° C., from 60° C. to 105° C., thanks to the use of ionic liquids (B) as hardeners.

As indicated above, the composition according to the invention takes account of the technical and regulatory constraints associated with composite vessels operating under pressure, for example at a pressure of between 200 and 900 bar, for on-board hydrogen storage. This new composition is specific to the wet filament winding implementing method, which is generally the most widely used by manufacturers.

Another object of the invention is the use of a composition (C) according to the invention to impregnate a bundle of fibers (F) by the wet process, the fibers (F) being chosen from
organic fibers chosen from polyethylene, poly(p-phenylene-2,6-benzobisoxazole) or PBO, aramid, polyamide, flax, polyester or other organic fibers;
inorganic fibers chosen from glass, carbon, silicon carbide, basalt or other inorganic fibers.

The fibers may be impregnated by immersion in a bath, by contact, by injection or by spraying. These impregnation techniques are well known to the person skilled in the art.

Another object of the invention is a method for manufacturing parts comprising a composite material operating under pressure, for example at a pressure of between 200 and 900 bar, by wet filament winding, comprising at least one step of impregnating a bundle of fibers (F) chosen from
organic fibers chosen from polyethylene, poly(p-phenylene-2,6-benzobisoxazole) or PBO, aramid, polyamide, flax, polyester or other organic fibers;
inorganic fibers chosen from glass, carbon, silicon carbide, basalt or other inorganic fibers,
with a composition (C) according to the invention.

More particularly, the method for manufacturing parts comprising a composite material operating under pressure comprises at least the following steps:
i) impregnating of a bundle of fibers (F) selected from
organic fibers chosen from polyethylene, poly(p-phenylene-2,6-benzobisoxazole) or PBO, aramid, polyamide, flax, polyester or other organic fibers;
inorganic fibers chosen from glass, carbon, silicon carbide, basalt or other inorganic fibers;
of a composition (C) according to the invention;
ii) winding the impregnated fibers around a liner or a mandrel;
iii) polymerizing the composition (C) at a temperature less than or equal to 170° C.

This method may also be used to manufacture parts comprising a composite material which do not require to be operated under pressure within the meaning of the invention.

The composite part may be a type II, III, IV or V pressure vessel for on-board storage of gaseous hydrogen. Preferably, the part is a Type IV vessel.

The impregnation may be carried out by immersion in a bath containing a composition (C) according to the invention, in contact with a composition (C) according to the invention, by injection or by spraying of a composition (C) according to the invention.

The polymerization may take place at maximum temperatures of 170° C. or less, for example at maximum temperatures of 60° C. to 170° C., 60° C. to 150° C., 60° C. to 130° C., 60° C. to 110° C., 60° C. to 105° C. The manufacturers choose the temperature according to their manufacturing constraints.

Said bundle of fibers (F) is impregnated with the composition (C), with a mass ratio of (F) of between 40 and 70% and a mass ratio of (C) of between 30 and 60%.

The bundle of fibers may be in the form of rovings, ribbons, a non-woven web or aggregate of loose fibers, or in woven form.

The composition (C) according to the invention may be used for the manufacture of vessels operating under pressure of types II, III, IV and V, comprising a composite material, for the on-board storage of gaseous hydrogen, in particular for both fixed and mobile applications, such as, for example, the hydrogen storage infrastructures, the transport of hydrogen for refueling, the hydrogen-powered rail vehicles, the buses, the trucks, the aircrafts, the boats and other hydrogen-powered vehicles, and hydrogen-powered cars.

The object of the invention is therefore the use of a composition (C) according to the invention, for the manufacture of a hydrogen vessel, in particular a type II, III, IV and V pressure vessel, made of composite material, for the on-board storage of gaseous hydrogen.

In the context of the present invention, a part or a vessel is said to operate under pressure when the nominal operating pressure is of the order of several hundred bars, for example at a nominal operating pressure of between 200 and 900 bars.

### DETAILED DESCRIPTION OF THE INVENTION

The present invention relates to a composition (C) characterized in that it comprises
(A) 70 to 95 parts by mass of an epoxy resin with a viscosity of less than or equal to 20 Pa·s, preferably between 1 and 20 Pa·s, more preferably between 1 and 10 Pa·s, at a temperature of between 20° C. and 25° C., and
(B) 5 to 30 parts by mass of a hardener dispersed in the resin,
per 100 parts by mass of resin present in the composition,
and in that the hardener is an ionic liquid containing a phosphonium cation of formula P(R₁R₂R₃R₄)⁺ wherein R₁, R₂, R₃ and R₄, which may be identical or different, represent a hydrogen atom, an alkyl radical having 1 to 18 carbon atoms or an aryl radical having 6 to 20 carbon atoms, said alkyl and aryl radicals being optionally substituted, and
an acetate anion of formula (R₅CO₂)⁻ wherein R₅ represents a hydrogen atom, an alkyl radical having 1 to 18 carbon atoms, an aryl radical having 6 to 20 carbon atoms, said alkyl and aryl radicals being optionally substituted, or
a phosphinate anion of formula (PO₂R₆R₇)⁻ wherein R₆ and R₇, which are identical or different, represent a hydrogen atom, an alkyl radical having 2 to 16 carbon atoms or an aryl radical having 6 to 20 carbon atoms, said alkyl and aryl radicals being optionally substituted.

For the purposes of the invention, an “alkyl” radical is a saturated, optionally substituted, linear, branched or cyclic carbon radical generally comprising from 1 to 18 carbon atoms, for example from 1 to 14 carbon atoms, for example from 1 to 10 carbon atoms. Examples of saturated, linear or branched alkyl are methyl, ethyl, propyl, butyl, pentyl, hexyl, octyl, nonyl, decyl, undecyl, dodecyl, tridecyl, tetradecyl, pentadecyl, hexadecyl and branched isomers thereof. Cyclic alkyl radicals include cyclopropyl, cyclobutyl, cyclopentyl, cyclohexyl, cycloheptyl, cyclooctyl, bicyclo[2,1,1]hexyl and bicyclo[2,2,1]heptyl radicals.

In the specific case of a phosphinate anion, the “alkyl” radical is a saturated, optionally substituted, linear, branched or cyclic carbon radical generally comprising from 2 to 16 carbon atoms, for example from 4 to 16 carbon atoms.

The term “aryl” refers to a mono- or poly-cyclic aromatic substituent generally comprising 6 to 20 carbon atoms, for example 6 to 10 carbon atoms. Examples include phenyl, benzyl, naphthyl and phenanthrenyl groups.

The alkyl and aryl radicals may be optionally substituted by one or more hydroxyl groups (—OH), one or more alkoxy groups (—O-alkyl); one or more aryloxy groups (—O-aryl); one or more halogen atoms chosen from fluorine, chlorine, bromine and iodine atoms; with alkyl and aryl as defined in the context of the present invention.

In the phosphonium cation, R₁, R₂, R₃ and R₄, which may be identical or different, represent
a hydrogen atom,
an alkyl radical chosen from methyl, ethyl, propyl, butyl, pentyl, hexyl, heptyl, octyl, nonyl, decyl, undecyl, dodecyl, tridecyl, tetradecyl, and branched isomers thereof,
an aryl radical chosen from phenyl and benzyl,
said alkyl and aryl radicals being optionally substituted.

The phosphonium cation may be selected from [(C₆H₁₃)₃(C₁₄H₂₉)P]⁺, [(C₄H₉)₃(C₁₄H₂₉)P]⁺, [(C₄H₉)₃(C₂H₅)P]⁺, [(C₈H₁₇)₄P]⁺, [(C₄H₉)₃(CH₃)P]⁺, [(iso-C₄H₉)₃(CH₃)P]⁺, [(H)₄P]⁺, [(CH₃)₄P]⁺, [(Ph)₄P]⁺, [(Ph)₃(CH₃)P]⁺, [(C₆H₁₃)₃(C₁₄H₂₉)P]⁺, [(CH₂OH)₄P] +.

More particularly, the phosphonium cation may be selected from [(C₆H₁₃)₃(C₁₄H₂₉)P]⁺, [(C₄H₉)₃(C₁₄H₂₉)P]⁺, [(C₄H₉)₃(C₂H₅)P]⁺, [(C₈H₁₇)₄P]⁺, [(C₄H₉)₃(CH₃)P]⁺, [(iso-C₄H₉)₃(CH₃)P]⁺, [(C₆H₁₃)₃(C₁₄H₂₉)P]⁺.

According to a first embodiment of the invention, in the composition, the ionic liquid contains a phosphinate anion of formula (PO₂R₆R₇)⁻ wherein R₆ and R₇, which may be identical or different, represent a hydrogen atom, an alkyl radical having 2 to 16 carbon atoms, an aryl radical having 6 to 20 carbon atoms, said alkyl and aryl radicals being optionally substituted, and a phosphonium cation as defined above.

In this first embodiment, the phosphinate anion of formula (PO₂R₆R₇)⁻ wherein R₆ and R₇, which may be identical or different, represent
a hydrogen atom,
an alkyl radical chosen from butyl, pentyl, hexyl, heptyl, octyl, nonyl, decyl, undecyl, dodecyl, tridecyl, tetradecyl, and branched isomers thereof,
an aryl radical chosen from phenyl and benzyl,
said alkyl and aryl radicals being optionally substituted.

The phosphinate anion may be selected from (PO₂H₂)⁻, (PO₂(C₇H₃₀)₂)⁻, [[(CH₃)₃CCH₂CH(CH₃)CH₂]₂P(O)O]⁻, (PO₂Ph₂)⁻.

The ionic liquid may contain a phosphinate anion of formula [[(CH₃)₃CCH₂CH(CH₃)CH₂]₂P(O)O]⁻ and a phosphonium cation as defined above.

In this first embodiment, the ionic liquid may be trihexyl(tetradecyl)phosphonium bis-2,4,4-(trimethylpentyl)phosphinate or CYPHOS® IL104 from Cytec Industries Inc.

In this first embodiment, when the ionic liquid contains a phosphinate anion as described above, the composition comprises 5 to 20 parts by mass of ionic liquid or liquids, per 100 parts by mass of epoxy resin present in the composition.

In all the variants and embodiments of the invention, the composition (C) may be polymerized under the action of the temperature depending on the desired application and the desired characteristics. The person skilled in the art will be able to choose and adapt these conditions.

According to a second embodiment of the invention, the composition comprises an ionic liquid which contains an acetate anion of formula (R₅CO₂)⁻ wherein R₅ represents a hydrogen atom, an alkyl radical having 1 to 18 carbon atoms, an aryl radical having 6 to 20 carbon atoms, said alkyl and aryl radicals being optionally substituted, and a phosphonium cation as defined above.

In this second embodiment, in the acetate anion, R₅ represents
a hydrogen atom,
an alkyl radical chosen from methyl, ethyl, propyl, butyl, pentyl, hexyl, heptyl, octyl, nonyl, decyl, undecyl, dodecyl, tridecyl, tetradecyl, and branched isomers thereof, and branched isomers thereof,
an aryl radical chosen from phenyl and benzyl,
said alkyl and aryl radicals being optionally substituted.

The acetate anion may be selected from ((CH₃)CO₂)⁻, ((C₅H₁₁)CO₂)⁻, ((CH₃CH₂CH(CH₃)CH₂CH₂)CO₂)⁻, ((C₇H₁₅)CO₂)⁻, ((CH₃CH₂CH₂CH₂CH(CH₃)CH₂CH₂) CO₂)⁻, ((CH₃)₃CCH₂CH(CH₃)CH₂CH₂CH₂)CO₂)⁻, (CH₃CH(CH₃)CH₂CH₂CH₂CH(CH₃)CH₂)CO₂)⁻, ((C₉H₁₉)CO₂)⁻.

In this second embodiment, when the ionic liquid contains an acetate anion as described above, the composition comprises 5 to 20 parts by mass of ionic liquid, per 100 parts by mass of epoxy resin present in the composition.

In this other embodiment, the ionic liquid may be trihexyl(tetradecyl)phosphonium decanoate or CYPHOS® IL 103 from Strem Chemicals Inc.

The epoxy resin (A) present in the composition may be, for example, of the bisphenol type, such as bisphenol A, bisphenol B, bisphenol F, bisphenol S, ortho-, meta-, para-cresol novolac.

The epoxy resin (A) may be Araldite® LY 566 bisphenol A resin, marketed by Huntsman.

The epoxy resin (A) has a viscosity of less than or equal to 20 Pa·s, preferably between 1 and 20 Pa·s, more preferably between 1 and 10 Pa·s, at a temperature of between 20° C. and 25° C.

The viscosity was measured at a temperature of between 20° C. and 25° C., using an ARES Rheometer apparatus from TA® instruments. The ARES rheometer uses a plan/plan geometry with 25 mm (upper geometry) and 40 mm (lower geometry) aluminum discs. The composition is deposited hot (60° C.) to the geometries and then cooled to between 20° C. and 25° C. to measure viscosity. The “DFS” Dynamic Frequency Sweep (strain controlled) 1-100 rad/s test is carried out with a strain of around 10%. The viscosity measurement is taken at a frequency of 6 rad/s.

The composition according to the invention may be prepared by mixing elements (A) and (B) as shown in the examples. In particular, the method consists in mixing an epoxy resin (A) and an ionic liquid (B) as defined above, until a homogeneous composition is obtained, at a temperature which prevents the polymerization of (A) from being initiated.

The composition may be prepared in a simple reactor (made of glass) equipped with a stirring blade and under air. The temperature may be controlled by a hot plate and a silicone oil bath.

The continuous mixing is a method of continuously dosing ingredients directly into the mixing area and, consequently, generating a continuous flow of mixed product at the mixer outlet. This principle guarantees a perfect control of the meeting point of the ingredients and therefore a unique distribution quality for the mixed product. The product obtained is therefore in the form of a homogeneous mixture. Any continuous mixer known to the person skilled in the art may be suitable for making the composition.

Without wishing to be bound by theory, the inventors have found that the use of ionic liquids as described above as hardeners in a composition according to the invention allows a polymerization via a catalytic and not an addition mechanism. The ionic liquids allows to reduce the amount of curing agent or hardener required to fully cure the epoxy matrix (i.e. 20-50 portions per 100 parts of resin or phr, for the standard amine systems). Indeed, the ionic liquid, under the effect of temperature, will allow the oxirane ring to open by the nucleophilic attack of the anion on the α carbon of this function.

This reaction referred to as activation reaction leads to the formation of alcoholate, a function that is reactive towards other epoxide units. A second step, referred to as propagation, consists of the homopolymerizing of the alcoholate units formed on the oxirane rings.

Under the right temperature conditions, this reaction continues until the epoxy matrix is completely cross-linked (conversion >95%).

It should be noted that thanks to the use of ionic liquids as described above, the composition (C) has a rapid polymerization compared with the epoxy matrix-based compositions used today. The polymerization time of the epoxy matrix in a composition (C) according to the invention is less than 12 hours, less than 10 hours, in particular less than or equal to 8 hours, in particular less than or equal to 6 hours, more particularly less than or equal to 4 hours, and even more particularly less than or equal to 2 hours.

Another object of the invention is the use of a composition (C) according to the invention to impregnate a bundle of fibers (F) by the wet process, the fibers (F) being chosen from
organic fibers chosen from polyethylene, poly(p-phenylene-2,6-benzobisoxazole) or PBO, aramid, polyamide, flax, polyester or other organic fibers;
inorganic fibers chosen from glass, carbon, silicon carbide, basalt or other inorganic fibers.

The bundle of fibers (F) may be in the form of rovings, ribbons, a non-woven web or aggregate of loose fibers, or in woven form.

The bundle of reinforcing fibers preferably comprises 1,000 to 70,000 filaments with a diameter of 3 to 100 um.

Preferably, the fibers (F) are carbon fibers. These include TORAYCA T720 carbon fibers from Toray®.

Another object of the invention is a method for manufacturing parts comprising a composite material operating under pressure, implemented by wet filament winding, comprising at least one step of impregnating a bundle of fibers (F) chosen from
organic fibers chosen from polyethylene, poly(p-phenylene-2,6-benzobisoxazole) or PBO, aramid, polyamide, flax, polyester or other organic fibers;
inorganic fibers chosen from glass, carbon, silicon carbide, basalt or other inorganic fibers.
with a composition (C) according to the invention.

More particularly, the method for manufacturing parts comprising a composite material operating under pressure comprises at least the following steps:
i) impregnating a bundle of fibers (F) selected from
organic fibers chosen from polyethylene, poly(p-phenylene-2,6-benzobisoxazole) or PBO, aramid, polyamide, flax, polyester or other organic fibers;
inorganic fibers chosen from glass, carbon, silicon carbide, basalt or other inorganic fibers,
of a composition (C) according to the invention;
ii) winding the impregnated fibers around a liner or a mandrel;
iii) polymerizing the composition (C) at a temperature less than or equal to 170° C.

As already indicated, the method of the invention also allows the manufacture of parts comprising a composite material that does not require operation under pressure within the meaning of the invention.

The part comprising a composite material may be a vessel operating under pressure, of types II, III, IV and V, for the on-board storage of the gaseous hydrogen. Preferably, the part is a type IV vessel.

The implementation by wet filament winding is a method well known to the person skilled in the art. In the context of this method, the fibers (F) are fed continuously from a roller and pass through a bath containing a composition (C) before being wound around a liner or a mandrel.

Said bundle of fibers (F) is impregnated with the composition (C), with a mass ratio of (F) of between 40 and 70% and a mass ratio of (C) of between 30 and 60%.

The bundle of fibers (F) may be in the form of rovings, ribbons, a non-woven web or aggregate of loose fibers, or in woven form.

In step i), the impregnation of the bundle of moving fibers (F) with the composition (C) is carried out continuously in a bath containing said composition (C) according to the invention, at a temperature that may range from 10 to 80° C., for example from 10 to 50° C.

The duration of this impregnation may range from a few seconds to a few minutes, for example, from 10 seconds to 5 minutes.

The impregnation bath contains the composition (C) according to the invention.

After step (i), the impregnated fibers are wound onto a mandrel at a temperature of 30° C. or less, for example between 20 and 30° C.

In step (i), the bundle of fibers (F) may be impregnated with the composition (C) using techniques well known to the person skilled in the art, such as those mentioned above.

Said bundle of fibers (F) is impregnated with the composition (C), with a mass ratio of (F) of between 40 and 70% and that of (C) of between 30 and 60%.

The implementation by wet filament winding is particularly suited to the manufacture of parts comprising a composite material operating at a nominal operating pressure as defined above, such as storage vessels operating under pressure.

The step of winding impregnated fibers (ii) is carried out continuously around a rotating mandrel. The winding is performed around a polymer liner for the type IV vessels, or around a metal mandrel for the type II and III vessels, or around a soluble or removable mandrel for the type V vessels.

The fiber deposition system is implemented by a fiber guiding that moves back and forth and laterally during the rotation of the liner or of the mandrel, so that the fibers are wound and/or deposited uniformly.

Two fiber deposition methods may be used to manufacture a cylindrical or spherical part. The circumferential winding, which allows the layer of fibers deposited to be oriented at 90° to the axis of the liner, and the helical winding, which allows the layer of fibers deposited to be oriented at an angle other than 90°. These two techniques are well known to the person skilled in the art and are described, for example, in Hojjati et al, Composites Engineering,

Vol. 5, Pages 51-59, 1995; De Carvalho et al, Composites Manufacturing, Vol. 6, Pages 79-84, 1995; Koussios et al., Journal of Materials Design and Applications, Vol. 219, Pages 25-35, 2005; Zu et al, Interfacial Interactions in Composites and Other Applications, Vol. 41, Pages 1312-1320, 2010.

At the end of the winding deposition phase, in step iii), the polymerization may take place at maximum temperatures of 170° C. or less, for example at maximum temperatures of 60° C. to 170° C., 60° C. to 150° C., 60° C. to 130° C., 60° C. to 110° C., 60° C. to 105° C. The manufacturers choose the temperature according to their manufacturing constraints.

This step iii) generally takes place in an oven or a tunnel furnace. The heating is maintained until the complete polymerization of the epoxy matrix of composition (C) (conversion>95%).

The implementation of filament winding may also be performed on a polymer liner, in particular a polyethylene or polyamide liner.

The liner is the inner coating of the vessel. It has two main functions, sealing the structure and acting as a mandrel. By rotating it, the fibers previously impregnated with the composition (C) are deposited directly on its outer surface.

In one embodiment, the liner is made of polyethylene.

In another embodiment, the liner is made of polyamide.

In another embodiment, the liner is metal, such as aluminum or stainless steel.

The composition (C) according to the invention has a rapid cure (only a few hours) and at low temperature as previously indicated, during the manufacture of composite pressure vessels of types II, III, IV and V, for the on-board storage of the gaseous hydrogen. The rapid curing and the possibility of low temperature curing of the composition are essentially due to the use of ionic liquid (B) as a hardener.

The composition (C) comprises an epoxy resin (A) as this type of thermosetting polymer is the most commonly used in the manufacture of pressure vessels for on-board hydrogen storage.

The composition (C) according to the invention may therefore be used to manufacture type II, III, IV and V composite material pressure vessels for the on-board storage of gaseous hydrogen, in particular for both fixed and mobile applications, such as hydrogen storage infrastructures, hydrogen transport for refueling, hydrogen-powered rail vehicles, buses, trucks, aircrafts, boats and other hydrogen-powered vehicles, and hydrogen-powered cars. The object of the invention is therefore the use of a composition (C) according to the invention, for the manufacture of a hydrogen vessel, in particular a vessel operating under pressure, of the types II, III, IV and V, comprising a composite material, for the on-board storage of gaseous hydrogen.

The vessels obtained in this way may be approved according to the criteria of the regulations currently in force (such as EC79 or R134).

### EXAMPLES

Protocol for the preparation of a composition according to the invention

The bisphenol A type epoxy resin Araldite® LY 566, marketed by Hunstman, has a viscosity of 10 Pa·s at 20° C. The Araldite® LY 566 epoxy resin is liquid at room temperature (20° C.-25° C.).

The resin is introduced into a thermostatically controlled reactor and then the ionic liquid CYPHOS® IL 104 (trihexyl(tetradecyl)phosphonium bis-2,4,4-(trimethylpentyl) phosphinate or [R₄PA]), marketed by Cytec Industries Inc. or the ionic liquid CYPHOS® IL 103 (trihexyl(tetradecyl)phosphonium decanoate), marketed by Strem Chemicals, is added at a rate of 10 portions by mass or pp or phr (10 portions Cyphos® LI 103 for 100 portions LY 556 resin). The mixture is stirred for approximately 20 minutes at 40° C.

Once homogenized, a composition according to the invention is obtained and may be used to impregnate reinforcement fibers. During this step, the composition is continuously diffused onto a TORAYCA T720 carbon fiber roving from Toray® at a temperature of between 10 and 50° C. This temperature may be adjusted by the person skilled in the art.

The roving impregnated with the composition (resin+ionic liquid) may then be wound onto the liner.

### Curing Cycle

The suggested curing cycles for polymerizing a composition as prepared above are 5 h with a polymerization step lasting:
2 h at 80° C. then 3 h at 130° C., or 2 h at 80° C. then 3 h at 105° C. for CYPHOS® IL 104 ionic liquid;
1 h at 50° C., then 1 h at 70° C., then 3 h at 105° C. or 130° C. CYPHOS® IL 103.

In summary, the compositions according to the invention may be used to prepare vessels for 1 to 2 days for wet filament winding applications, particularly for type IV hydrogen vessels. These compositions address the issue of curing times by offering polymerization times on thick composites (>30 mm) of less than 5 hours. Moreover, these compositions may be used with both polyethylene (PE) and polyamide (PE) liners, the two main polymer materials used to manufacture type IV hydrogen vessels. Lastly, these compositions allow to replace amine hardeners, which are unhealthy.

1. A composition, comprising:
70 to 95 parts by mass of an epoxy resin with a viscosity of less than or equal to 20 Pa·s, at a temperature of between 20° C. and 25° C., and
5 to 30 parts by mass of a hardener dispersed in the resin, per 100 parts by mass of resin present in the composition,
wherein the hardener is an ionic liquid containing a phosphonium cation of formula P(R₁R₂R₃R₄)⁺ wherein R₁, R₂, R₃ and R₄, which may be identical or different, represent a hydrogen atom, an alkyl radical having 1 to 18 carbon atoms or an aryl radical having 6 to 20 carbon atoms, said alkyl and aryl radicals being optionally substituted, and
an acetate anion of formula (R₅CO₂)⁻ wherein R₅ represents a hydrogen atom, an alkyl radical having 1 to 18 carbon atoms, an aryl radical having 6 to 20 carbon atoms, said alkyl and aryl radicals being optionally substituted, the viscosity being measured at a temperature of between 20° C. and 25° C., using an ARES Rheometer apparatus from the company TA® instruments.

2. The composition according to claim 1, wherein in the phosphonium cation R₁, R₂, R₃ and R₄, which may be identical or different, represent
a hydrogen atom,
an alkyl radical chosen from methyl, ethyl, propyl, butyl, pentyl, hexyl, heptyl, octyl, nonyl, decyl, undecyl, dodecyl, tridecyl, tetradecyl, and branched isomers thereof,
an aryl radical chosen from phenyl and benzyl,
said alkyl and aryl radicals being optionally substituted.

3. The composition according to claim 1, wherein the phosphonium cation is chosen from [(C₆H₁₃)₃(C₁₄H₂₉)P]⁺, [(C₄H₉)₃(C₁₄H₂₉)P]⁺, [(C₄H₉)₃(C₂H₅)P]⁺, [(C₈H₁₇)₄P]⁺, [(C₄H₉)₃(CH₃)P]⁺, [(iso-C₄H₉)₃(CH₃)P]⁺, [(H)₄P]⁺, [(CH₃)₄P]⁺, [(Ph)₄P]⁺, [(Ph)₃(CH₃)P]⁺, [(C₆H₁₃)₃(C₁₄H₂₉)P]⁺, [(CH₂OH)₄P]⁺.

4. The composition according to claim 1, wherein the ionic liquid contains an acetate anion of formula (R₅CO₂)⁻, wherein R₅ represents
a hydrogen atom,
an alkyl radical chosen from methyl, ethyl, propyl, butyl, pentyl, hexyl, heptyl, octyl, nonyl, decyl, undecyl, dodecyl, tridecyl, tetradecyl, and branched isomers thereof, and branched isomers thereof,
an aryl radical chosen from phenyl and benzyl,
said alkyl and aryl radicals being optionally substituted.

5. The composition according to claim 4, wherein the acetate anion is chosen from ((CH₃)CO₂)⁻, ((C₅H₁₁)CO₂)⁻, ((CH₃CH₂CH(CH₃)CH₂CH₂)CO₂)⁻, ((C₇H₁₅)CO₂)⁻, ((CH₃CH₂CH₂CH₂CH(CH₃)CH₂CH₂)CO₂)⁻, ((CH₃)₃CCH₂CH(CH₃)CH₂CH₂CH₂)CO₂)⁻, (CH₃CH(CH₃)CH₂CH₂CH₂CH(CH₃)CH₂)CO₂)⁻, ((C₉H₁₉)CO₂)⁻.

6. The composition according to claim 1, comprising 5 to 20 parts by mass of ionic liquid per 100 parts by mass of epoxy resin present in the composition.

7. A composition comprising:
70 to 95 parts by mass of an epoxy resin with a viscosity of less than or equal to 20 Pa·s, at a temperature of between 20° C. and 25° C., and
5 to 30 parts by mass of a hardener dispersed in the resin,
per 100 parts by mass of resin present in the composition,
and wherein the hardener is an ionic liquid containing a phosphonium cation of formula P(R₁R₂R₃R₄)⁺ wherein R₁, R₂, R₃ and R₄ are as defined in claim 1, and
a phosphinate anion of formula (PO₂R₆R₇)⁻ wherein R₆ and R₇, which may be identical or different, represent
a hydrogen atom,
an alkyl radical chosen from butyl, pentyl, hexyl, heptyl, octyl, nonyl, decyl, undecyl, dodecyl, tridecyl, tetradecyl, and branched isomers thereof,
an aryl radical chosen from phenyl and benzyl,
said alkyl and aryl radicals being optionally substituted by a hydrogen atom, an alkyl radical having 2 to 16 carbon atoms, an aryl radical having 6 to 20 carbon atoms, said alkyl and aryl radicals being optionally substituted,
said composition capable to impregnate a bundle of fibers by the wet process, the fibers being selected from
organic fibers chosen from polyethylene, poly(p-phenylene-2,6-benzobisoxazole) or PBO, aramid, polyamide, flax and polyester fibers; and/or
inorganic fibers chosen from glass, carbon, silicon carbide and basalt fibers.

8. The composition according to claim 7, wherein when the composition comprises a hardener which is an ionic liquid containing a phosphinate anion, said phosphinate anion is of formula [[(CH₃)₃CCH₂CH(CH₃)CH₂]₂P(O)O]⁻.

9. A method for manufacturing parts comprising a composite material operating under pressure, the method comprising at least the following:
i) impregnating, with a composition according to claim 1, a bundle of fibers selected from
organic fibers chosen from polyethylene, poly(p-phenylene-2,6-benzobisoxazole) or PBO, aramid, polyamide, flax and polyester fibers; or
inorganic fibers chosen from glass, carbon, silicon carbide and basalt fibers;
ii) winding the impregnated fibers around a liner or a mandrel;
iii) polymerizing the composition at a temperature less than or equal to 170° C.

10. The method according to claim 10, wherein said impregnated bundle of fibers includes a mass ratio of fibers of between 40 and 70% and a mass ratio of the composition of between 30 and 60%.

11. A method, comprising: manufacturing a hydrogen vessel of the types II, III, IV and V with a composite material having the composition of claim 1, for the on-board storage of gaseous hydrogen.

12. The composition according to claim 7, wherein the viscosity is between 1 and 20 Pa·s.

13. The composition according to claim 12, wherein the viscosity is between 1 and 10 Pa·s.

14. The composition according to claim 1, wherein the viscosity is between 1 and 20 Pa·s.

15. The composition according to claim 14, wherein the viscosity is between 1 and 10 Pa·s.

16. A method for manufacturing parts comprising a composite material operating under pressure, the method comprising at least the following:
i) impregnating, with a composition according to the composition of claim 7, a bundle of fibers selected from organic fibers chosen from polyethylene, poly(p-phenylene-2,6-benzobisoxazole) or PBO, aramid, polyamide, flax and polyester fibers; or
inorganic fibers chosen from glass, carbon, silicon carbide and basalt fibers;
ii) winding the impregnated fibers around a liner or a mandrel;
iii) polymerizing the composition at a temperature less than or equal to 170° C.

17. The method according to claim 16, wherein said impregnated bundle of fibers includes a mass ratio of fibers of between 40 and 70% and a mass ratio of the composition of between 30 and 60%.
